(19) United States
(12) Patent Application Publication
(10) Pub. No.: US 2005/0262084 A1
(43) Pub. Date: Nov. 24, 2005

(54) Storage control device and access control method

(76) Inventor: Aki Tomita, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 10/876,694

(22) Filed: Jun. 28, 2004

(30) Foreign Application Priority Data
May 7, 2004 (JP) 2004-138618

(51) Int. Cl. G06F 7/00

(52) U.S. Cl. 707/9

(57) ABSTRACT

In a case where an object ID unique to a region in a disk drive is included in a read request coming from a client terminal, first management means is provided for content reading from the region indicated by the object ID in the disk drive. In the case of a unique ID which is unique to the content and exhibits some change every time its corresponding content is updated, second disk management means is provided for making access to the disk drive based on the unique ID to execute an access request.

### CROSS-REFERENCES TO RELATED APPLICATIONS

This application relates to and claims priority from Japanese Patent Application No. 2004-138618, filed on May 7, 2004, the entire disclosure of which is incorporated herein by reference.

### BACKGROUND OF THE INVENTION

The present invention relates to a storage control device that makes access to one or more storage devices in response to an external request, and an operating program for the same, and to an access control method for the storage device(s).

At the time of making access to a disk drive which stores objects, using an object ID has been popular for content management. Here, an object is a collection of data, i.e., a data content, and the object ID is an identifier specifically provided to identify the storage region of that data content. As an alternative to a storage device using an object ID for content management, a storage device using a unique ID has recently been receiving attention. The unique ID is an identifier unique to the corresponding data content, and it undergoes a change whenever even a one bit change occurs in the data content. Content management using such a unique ID is disclosed in U.S. Pat. No. 5,978,791 and WO 200139043, for example.

Content management using a unique ID has three advantages. The first advantage is that it provides a WORM (Write One Read Many) attribute, and the second advantage is that a client can ensure whether the received contents are real contents corresponding to the ID. The third advantage is that a storage device including a disk drive provides clients with a data content whose storage location is transparent. Among these advantages, the one attracting the most attention is the first advantage, i.e. the WORM attribute, which is disclosed in U.S. Pat. No. 5,978,791, in that electronic records, which are generally easy to tamper with, can be made as trustworthy and reliable as paper records. For example, as part of the U.S. SEC Rule 17a-4, broker-dealers are required to preserve electric communications relating to the business of a firm, including the company's own securities dealings, brokered dealings, and sales, for a period of three years, or for two years in an accessible place. To comply with such a rule, the use of a unique ID is becoming popular for content management.

### SUMMARY OF THE INVENTION

With content management using an object ID, a content update will not change the object ID unless the content storage region is changed. With content management using a unique ID, on the other hand, the unique ID changes in response to every content update. This requires clients to keep track of the changing unique IDs as such, thereby putting a substantial burden on the clients. What is more, application programs for accessing storage devices that store data contents mostly are based on content management using object IDs, and thus they are not compatible with content management using unique IDs.

That is, even with the advantage of the WORM attribute, content management using unique IDs disadvantageously places the burden of ID management and other difficulties on the clients and is not compatible with many existing application programs.

In order to solve such problems, a first aspect of the present invention is directed to a storage control device which allow access, in response to an external request, to one or more that store devices storing objects, that is, collections of data. Such a storage control device is provided with first storage management means which, when a read request coming from the outside includes an object ID that is unique to a region in the storage device, reads out the object from the region indicated by the object ID and transmits that object to the outside, and second storage management means which, when an access request coming from the outside includes a unique ID that is unique to an object and changes every time the object is updated, allows access to the storage device based on the unique ID to execute the access request.

Herein, in the storage control device, the first and second storage management means may be provided with different communication ports for communications with the outside, or they may be provided with communications control means for allocating requests coming from the outside to either the first or second storage management means depending on the request content.

A second aspect of the present invention is directed to a computer-operable operation program of a storage control device that allows access, in response to an external request, to one or more storage devices that store objects (collections of data). The operation program performs a first storage management step in which, when a read request coming from the outside includes an object ID that is unique to a region in the storage device, the object is read from the region indicated by the object ID and is transmitted to the outside, and a second storage management step in which, when an access request coming from the outside includes a unique ID that is unique to an object and changes every time the object is updated, access to the storage device is allowed based on the unique ID to execute the access request.

A third aspect of the present invention is directed to an access control method for allowing access in response to an external request to one or more storage devices that store objects (collections of data). The access control method includes a first storage management step in which, when a read request coming from the outside includes an object ID that is unique to a region in the storage device, the object is read from the region indicated by the object ID for transmission to the outside, and a second storage management step in which, when an access request coming from the outside includes a unique ID that is unique to an object and changes every time the object is updated, access to the storage device is allowed based on the unique ID to execute the access request.

### BRIEF DESCRIPTION OF THE DRAWINGS

FIG. 1 is a block diagram showing the structure of a storage device representing a first embodiment of the present invention;

FIG. 2 is a block diagram showing the hardware structure of the storage device;

FIGS. 3A to 3E are diagrams showing the structures of various tables;

FIGS. 4A to 4F are diagrams showing the data structures of various commands and replies therefor;

FIGS. 5A to 5F are diagrams showing the data structures of various commands and replies therefor;

FIG. 6 is a flowchart of a content creation process in the storage device;

FIG. 7 is a flowchart of a content update process in the storage device;

FIG. 8 is a flowchart of a content read process (designated ID type is unique ID) in the storage device;

FIG. 9 is a flowchart of another content read process (designated ID type is object ID) in the storage device;

FIG. 10 is a flowchart of an ID list acquisition process in the storage device;

FIG. 11 is a flowchart of an object ID acquisition process in the storage device; and

FIG. 12 is a flowchart of an object ID distribution process in the storage device.

### DESCRIPTION OF THE PREFERRED EMBODIMENT

In the following description, a storage device representing an embodiment of the present invention will be described with reference to the accompanying drawings.

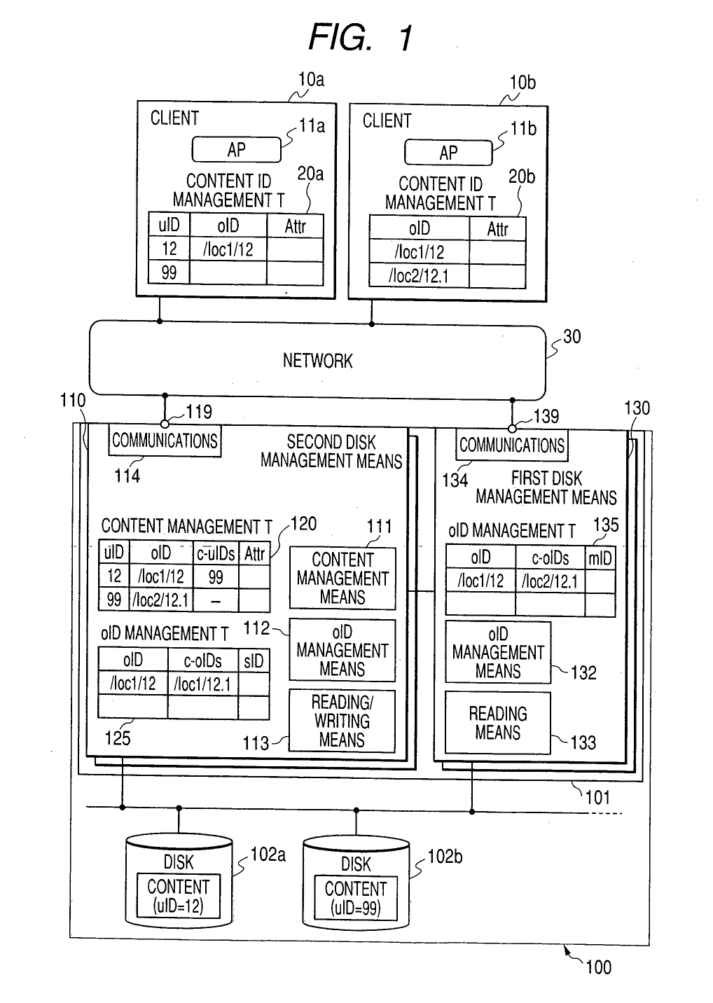

Referring to FIG. 1, a storage device 100 of the present embodiment is connected to a plurality of computers (hereinafter, referred to as “client terminals”) 10a and 10b through a network 30. This storage device 100 is provided with a plurality of disk drives 102a, 102b, and others, and a storage control device 101 which controls access to the disk drives 102.

The storage control device 101 includes, in terms of function, first disk management means 130 and second disk management means 110. These components are provided for executing processes upon the storage regions of the disk drives 102. Specifically, the first disk management means 130 carries out a read process based on a specific object ID. The second disk management means 110 carries out a read/write process and others based on a unique ID, which is unique to the data content and changes every time the data content is updated. The storage control device 101 is provided with both the disk management means 130 and 110.

The first disk management means 130 is provided with oID management means 132 for management of object IDs; read means 133 for reading the data content from the region specified by an object ID in the disk drive 102; an oID management table 135 for storage of object IDs and others; and communications control means 134 for effecting communication with the outside.

The second disk management means 110 is provided with content management means 111; oID management means 112; read/write means 113 for data content reading and writing from/to the disk drives 102; a content management table 120 for storage of the interrelation between a unique ID and an object ID; an oID management table 125 for storage of object IDs and others; and communications control means 114 for effecting communication with the outside. Specifically, the content management means 111 generates a unique ID for a data content written into the disk drive 102, and it performs mapping between the resulting unique ID and the object ID corresponding thereto. The oID management means 112 generates an object ID for the content written into the disk drive 102, and it manages the resulting object ID.

The communications control means 134 in the first disk management means 130 is provided with its own communications port 139, and the communications control means 114 in the second disk management means 110 is provided with its own communications port 119. The communications ports 139 and 119 are both connected to the network 30.

The client terminal 10a includes an application program 11a and a content ID management table 20a. Similarly, the client terminal 10b includes an application program 11b and a content ID management table 20b. For transmission of various requests to the storage device 100, the client terminal 10a uses unique IDs, and the client terminal 10b uses object IDs. Thus, in the client terminal 10a, using unique IDs is a prerequisite for the application program 11a, and the content ID management table 20a of the client terminal 10a stores unique IDs. In the client terminal 10b, using object IDs is a prerequisite for the application program 11b, and the content ID management table 20b of client terminal 10b stores object IDs.

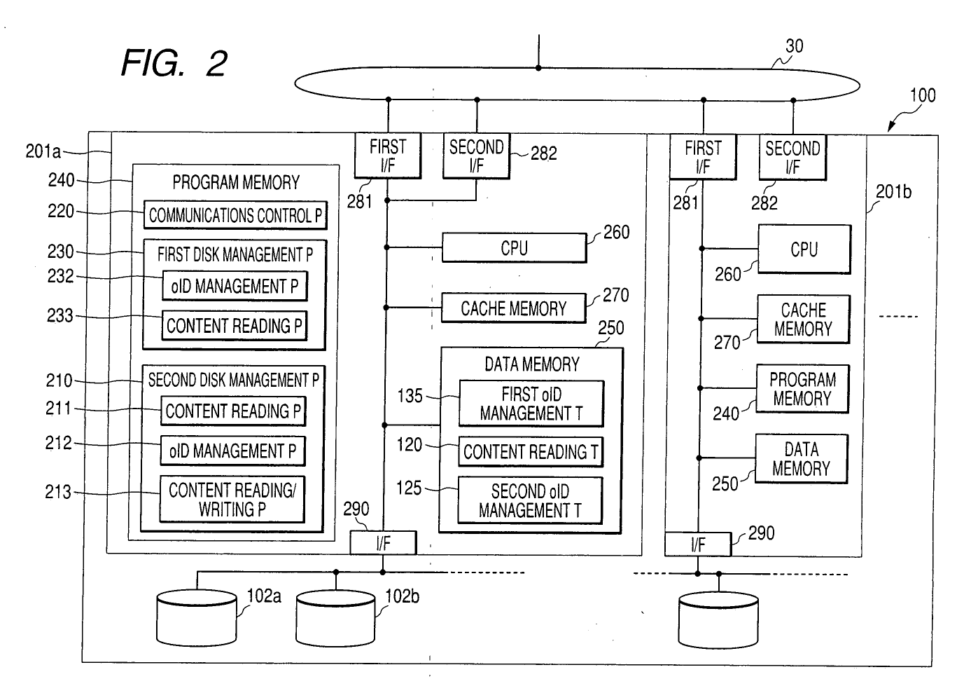

Referring to FIG. 2, the storage control device 101 of the storage device 100 is structured, in terms of hardware, by a plurality of controller units 201a, 201b, and others. The controller unit 201 is provided with a program memory 240 for storing various programs; a data memory 250 for storing the tables 120, 125, 135, and others; a CPU 260 for executing the programs stored in the program memory 240; a cache memory 270 for temporarily storing contents to be stored or which have been stored in the disk drives 102; first and second front interfaces 281 and 282, both connected to the network 30; and a back interface 290 for effecting data transmission and reception between the disk drives 102 and other controller units 201.

The program memory 240 stores a communications control program 220 for communications with terminals and others over the network 30; a first disk management program 230 for operating the first disk management means 130; and a second disk management program 210 for operating the second disk management means 110. The first disk management program 230 includes a content management program 232 for operating the content management means 132, and a content reading program 233 for operating the read means 133. The second disk management program 210 includes a content management program 211 for operating the content management means 111; an oID management program 212 for operating the oID management means 132; and a content reading/writing program 213 for operating the read/write means 113. In other words, the first and second disk management means 130 and 110 of FIG. 1 both operate in response to the CPU 260 executing the disk management programs 230 and 210 stored in the program memory 240.

Further, the communications control means 134 of the first disk management means 130 of FIG. 1 is structured by the program memory 240 storing the communications control program 220, the CPU 260 executing the program 220, and the first front interface 281. Similarly, the communications control means 114 of the second disk management means 110 of FIG. 1 is structured by the program memory 240 storing the communications control program 220, the CPU 260 executing the program 220, and the second front interface 282.

Here, the reason why the controller unit 201 is plurally provided is to correspond to a plurality of disk management means 130 and 110.

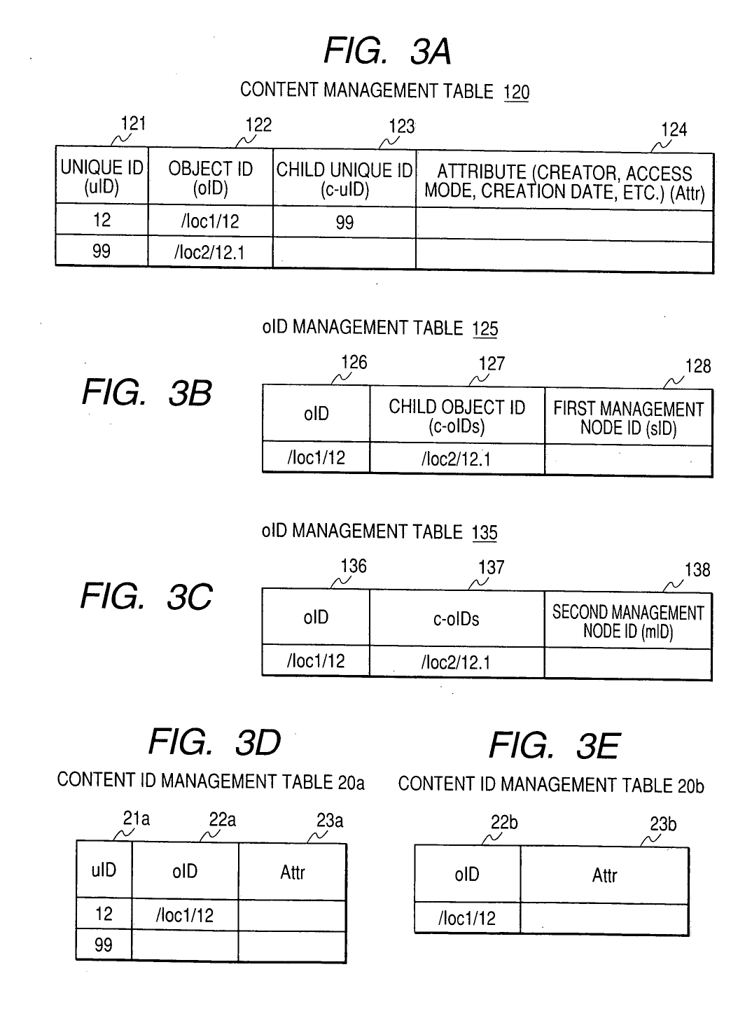

FIG. 3A shows an example of the table structure of the content management table 120 of the second disk management means 110. Specifically, the content management table 120 includes a unique ID column 121 for listing unique IDs; an object ID column 122 for listing the object ID corresponding to a unique ID; a Child unique ID column 123 for listing a unique ID that is newly provided when the content identified by a unique ID is updated; and an attribute column 124 for listing identifying attributes of the content given an unique ID, e.g., creator name, and creation time and date.

FIG. 3B shows an example of the table structure of the oID management table 125 of the second disk management means 110. Specifically, the oID management table 125 includes an object ID column 126 for listing an object ID; a Child object ID column 127 for listing an object ID that is newly provided when the content in the disk region identified by the object ID is updated; and a first management node ID column 128 for listing an ID for identifying one specific first disk management means 130 out of those plurally provided.

As seen from FIG. 3C, the oID management table 135 of the first disk management means 130 has basically the same structure as the oID management table 125 of the second disk management means 110. That is, the table 135 has an object ID column 136; a Child object ID column 137; and a second management node ID column 138 for listing an ID for identifying one specific second disk management means 110 from those plurally provided.

FIG. 3D shows an example of the table structure of the content ID management table 20a of the client terminal 10a, including the application program 11a, a prerequisite for which is usage of unique IDs. Specifically, the content ID management table 20a includes a unique ID column 21a for listing a unique ID; an object ID column 22a for listing an object ID corresponding to the unique ID; and an attribute column 23a for listing identifying attributes of the content identified by the unique ID.

FIG. 3E shows an example of the table structure of the content ID management table 20b of the client terminal 10b, including the application program 11b, a prerequisite for which is usage of object IDs. Specifically, the content ID management table 20b includes an object ID column 22b for listing object IDs, and an attribute column 23b for listing an identifying attributes of the content stored in the disk region identified by the object ID.

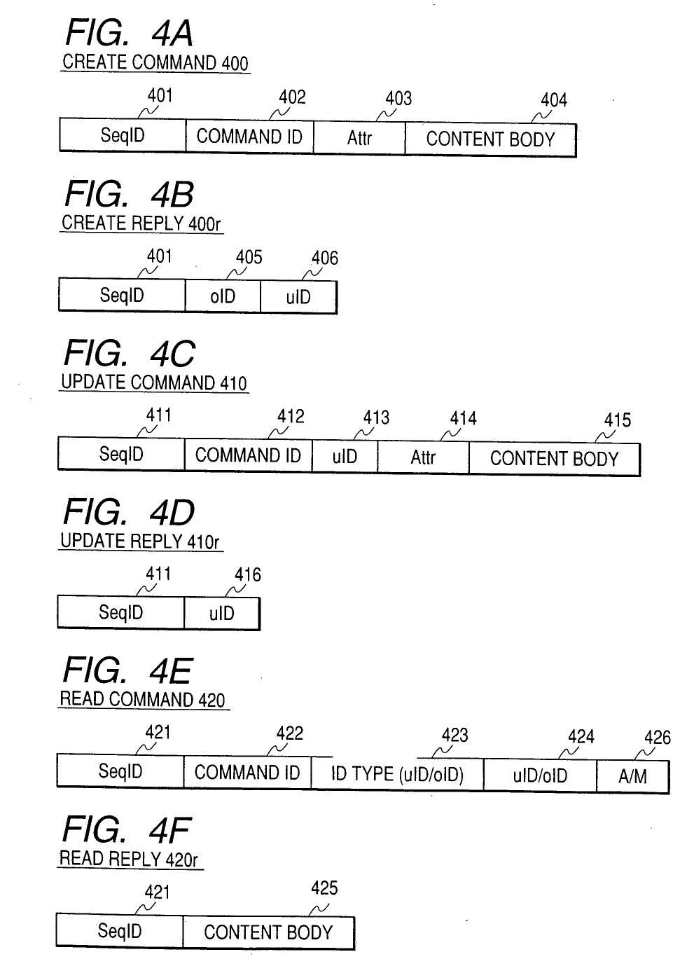

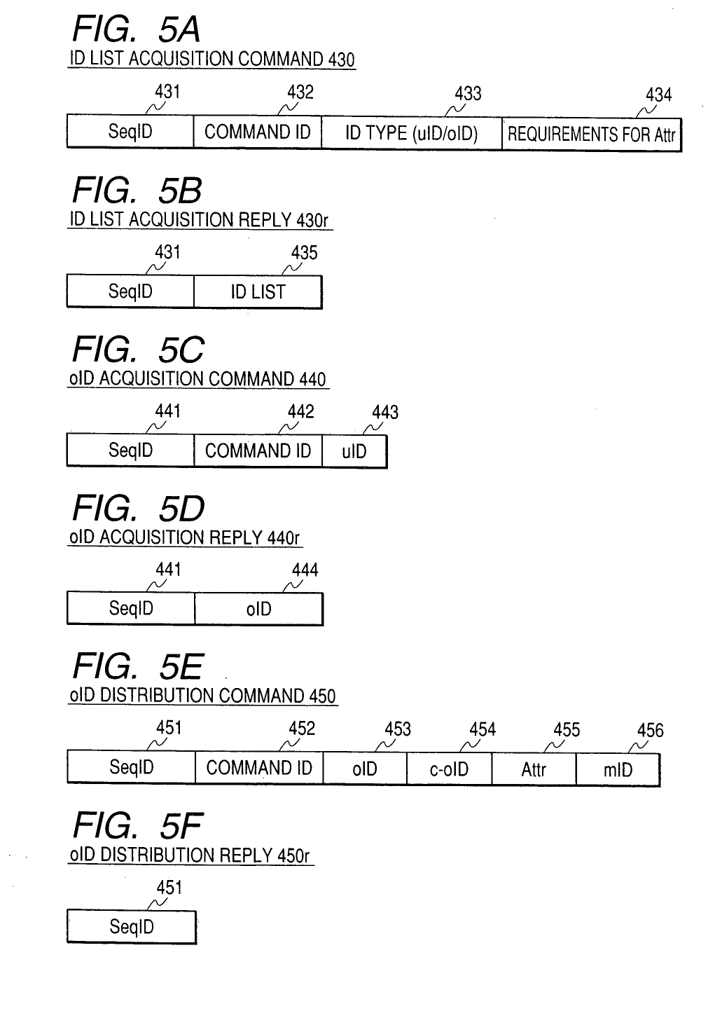

Referring to FIGS. 4A to FIG. 5D, the data structures of various commands coming and going between the client terminal 10a or 10b and the storage device 100 will be described next. Herein, although not shown in the drawings, such commands are each provided with a TCP header and an IP header, for example.

As shown in FIG. 4A, a create command 400 coming from the client terminal 10a includes a sequence ID 401; a command ID 402; a content body attribute 403; and the contents itself 404 to be created. As shown in FIG. 4B, a create reply 400r to be forwarded back to the client terminal 10a from the storage device 100 includes the sequence ID 401; a unique ID 406 that is provided by the storage device 100 to the contents; and an object ID 405 corresponding to the unique ID. In the present embodiment, the client terminal 10a which has forwarded a create request is provided with a create-request reply 400r, thereby informing the client terminal 10a of the object ID together with the unique ID. Alternatively, the client terminal 10a may be informed only of the unique ID.

As shown in FIG. 4C, an update command 410 coming from the client terminal 10a includes a sequence ID 411; a command ID 412; a unique ID 413 that is provided to the contents before being updated; an attribute 403 of the content body after update; and a content body 404 after update. As such, in the present embodiment, updating a content requires a unique ID, unlike creating contents. As shown in FIG. 4D, an update reply 410r to be forwarded back to the client terminal 10a from the storage device 100 includes the sequence ID 411, and a unique ID 416 that is provided by the storage device 100 to the contents after update.

All of the above-described commands, i.e., the create command 400, the create reply 400r, the update command 410, and the update reply 410r, are coming and going between the client terminal 10a and the second disk management means 110 in charge of content management based on unique IDs. More specifically, the client terminal 10a here employs the application program 11a with a prerequisite that unique IDs are used.

As shown in FIG. 4E, a read command 420 coming from the client terminals 10a and 10b includes a sequence ID 421; a command ID 422; an ID type 423; an ID 424; and an A/M flag 426. In more detail, the ID type 423 shows whether to use a unique ID or an object ID for identification of a read-out content, and the ID 424 specifies the ID type. The A/M flag 426 shows, if the specified ID type is the object ID, whether to read the latest content automatically, or to read the content identified by the object ID. As shown in FIG. 4F, a read reply 420r to be forwarded back to the client terminals 10a and 10b from the storage device 100 includes the sequence ID 421, and the contents 425. Here, if the read command 420 identifies the unique ID as the ID type, the read command 420 and the corresponding read reply are transmitted and received between the client terminal 10a, which assumes use of unique IDs, and the second disk management means 110 in charge of content management, which is based on unique ID's. More specifically, the client terminal 10a here is the one including the application program 11a with a prerequisite for usage of unique IDs. Similarly, if the read command 420 identifies the object ID as the ID type, the read command 420 and the corresponding read reply are transmitted and received between the client terminal 10a or 10b and the first disk management means 130 in charge of content management based on object IDs.

For requesting a series of IDs for contents at a location, i.e., for requesting an ID list, an ID list acquisition command 430 is provided by the client terminals 10a and 10b. As shown in FIG. 5A, the ID list acquisition command 430 includes a sequence ID 431, a command ID 432, an ID type 433, and an attribute requirement 434. Specifically, the ID type 433 shows which ID type a requested ID list is asking for: unique ID or object ID. Here, the attribute requirement 434 shows attributes relating to any new contents, and a series of updated contents updating those new contents. When IDs of contents created by a specific content creator are needed, the name of the content creator is stored in the attribute requirement 434. When IDs of contents created after a specific creation date are needed, a creation date is stored therein. As shown in FIG. 5B, an ID list acquisition reply 430r to be forwarded back to the client terminals 10a and 10b from the storage device 100 includes the sequence ID 431, and an ID list 435 of the ID type designated by the ID list acquisition command 430.

For requesting an object ID for a specific unique ID, an oID acquisition command 440 is provided by the client terminal 10a. As shown in FIG. 5C, the oID acquisition command 440 includes a sequence ID 441, a command ID 442, and a unique ID 443. In reply to the oID acquisition command 440, an oID acquisition reply 440r is forwarded back to the client 10a from the storage device 100. As shown in FIG. 5D, the oID acquisition reply 440r includes the sequence ID 441, and an object ID 444 corresponding to the unique ID 443 designated by the oID acquisition command 440. Here, the oID acquisition command and reply are those coming and going between the client terminal 10a, including the application program 11a, presuming usage of unique IDs, and the second disk management means 110 in charge of content management based on unique IDs.

Referring to FIGS. 5E and 5F, the oID distribution command 450 and the reply 450r therefor will be described next. Unlike the above-described commands, the command 450 and its reply 450r are those coming and going between the first disk management means 130 and the second disk management means 110 of the storage device 100. As will be described later, the oID distribution command 450 is forwarded to the first disk management means 130 when the second disk management means 110 receives a create command or an update command. The oID distribution command 450 includes a sequence ID 451, a command ID 452, an object ID 453, a c-object ID 454, an attribute 455, and a second management node ID 456 for identifying the second disk management means from which the command comes. The oID distribution reply 450r to be forwarded back to the second disk management means 110 from the first management means 130 includes the sequence ID 451.

The operation of the storage control device 101 of the present embodiment will be described next.

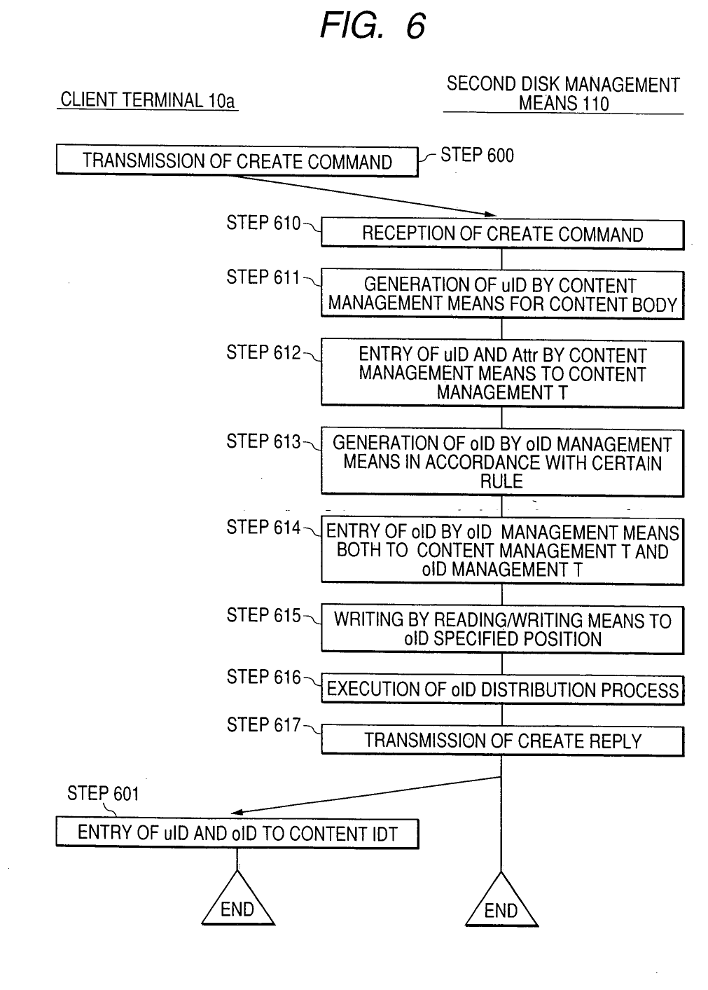

Referring first to the flowchart of FIG. 6, for description of the operation of the storage control device 101, a case is assumed where a create command is forwarded from the client terminal 10a using the application program 11a, which presumes usage of unique IDs.

For performing creation and writing in the storage device 100, the client terminal 10a forwards the create command 400 of FIG. 4A to the storage device 100 (S600). The create command 400 is derived by providing the command itself 404 with the corresponding attribute 403, the command ID 402, and the sequence ID 401. When the create command 400 is received by the communications control means 114 of the second disk management means 110 (S610), the content management means 111 creates a unique ID for the content body structuring the create command (S611). Then, the resulting unique ID and the content attribute in the create command are both entered into the content management table 120 (S612). The oID management means 112 creates an object ID for use to specify the storage position of the contents received in accordance with a predetermined rule (S613), and the resulting object ID is entered into both the content management table 120 and the oID management table 125 (S614). Thereafter, the read/write means 113 writes the contents to the position specified by the object ID (S615). After the contents is written into the disk drive 102, the oID management means 112 carries out distribution of oID to the first disk management means, a process that will be described later (S616). Through this process, the object ID provided to the newly-created content is communicated to the first disk management means 130. After writing of the new content is finished (S615), and after the oID distribution process is through (S616), the communications control means 114 forwards the creation reply 400r of FIG. 4B to the client terminal 10a (S617). As described above, the creation reply 400r includes the sequence ID 401, which is the same as the sequence ID of the creation command 400, the object ID 405 provided to the new contents, and the unique ID 406. When receiving the creation reply 400r, the client terminal 10a refers to the sequence ID therein to see what contents correspond to the new contents, and it makes entries noting the unique ID and its corresponding object ID in the row listing the content attributes in the content ID management table 20a (S601). The thus entered object ID and unique ID are used for content update, ID list request, and the like, the details of which are left for later description.

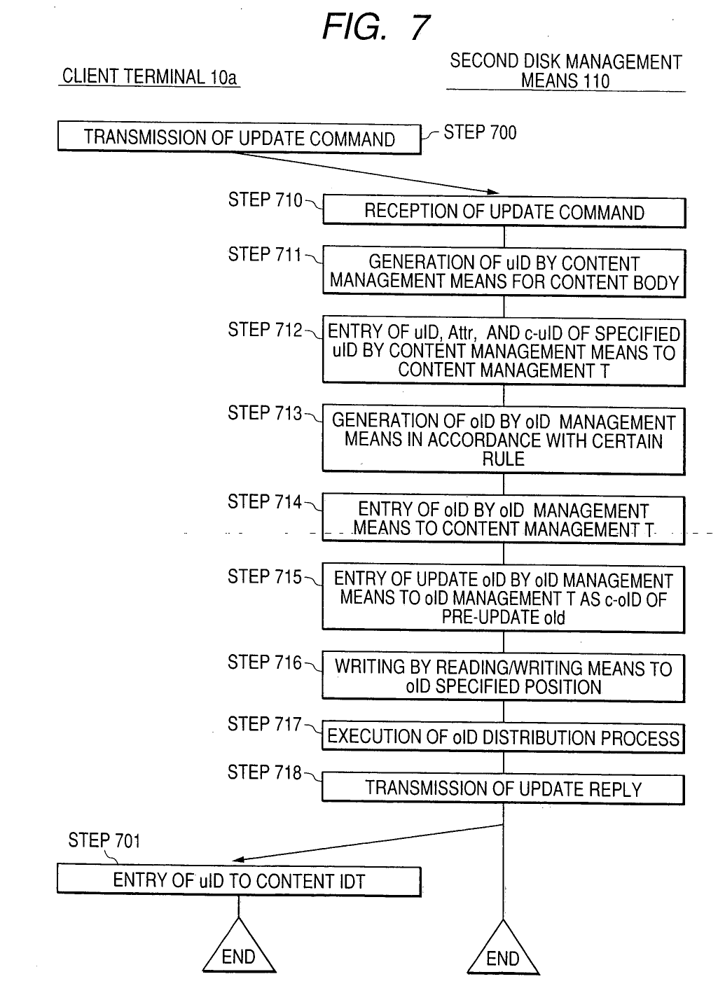

Referring to the flowchart of FIG. 7, the operation of the storage control device 101 will be described next, assuming a case where an update command is forwarded from the client terminal 10a using the application program 11a, which presumes usage of unique IDs.

For updating the content stored in the storage device 100, the client terminal 10a forwards the update command 410 of FIG. 4C to the storage device 100 (S700). The update command 410 is derived by providing, to the contents 415 after update, the corresponding attribute 414, the unique ID 413 for the pre-update content acquired from the second disk management means 110 of the storage device 100, the command ID 412, and the update command 410 provided with the sequence ID 411. When the update command 410 is received by the communications control means 114 of the second disk management means 110 (S710), the content management means 111 creates a unique ID for the updated contents contained in the update command (S711). As shown in FIG. 3A, the resulting unique ID “99” and the content attribute in the update command are both entered into the content management table 120 (S712). Here, entry of the unique ID “99” is made as a child unique ID (c-uID) of the pre-update unique ID “12”. The oID management means 112 then creates an object ID that specifies the storage position of the updated content body received in accordance with a predetermined rule (S713), and the resulting object ID is entered into the content management table 120 (S714). As shown in FIG. 3C, the update object ID “/loc2/12.1” is entered as a child object ID (c-oID) of the pre-update object ID “/loc1/12” (S715). Thereafter, the read/write means 113 writes the updated content itself in the position specified by the update object ID (S716). Here, as shown in FIG. 1, the region in the disk drive 102 in which the update contents (uID=99) are written is different from that of the pre-update contents itself (uID=12), and thus the pre-update contents itself (uID=12) remains in the disk drive 102. This means that the present embodiment allows content WORM. After the updated contents have been written into the disk drive 102, the oID management means 112 carries out the oID distribution process, which will be described later (S717). Through this process, the object ID provided to the updated content is communicated to the first disk management means 130. After writing of the updated content is finished (S716), and after the oID distribution process is through (S717), the communications control means 114 forwards the update reply 410r of FIG. 4D to the client terminal 10a (S718). As described above, the update reply 410r includes sequence ID 411, which is the same as the sequence ID of the update command 410, and the unique ID 405 provided to the updated content. When the update reply 410r is received, the client terminal 10a refers to the sequence ID therein to see which content item corresponds to the request, and it makes an entry of the unique ID to the row listing the content attributes in the content ID management table 20a (S701). In the present embodiment, as shown in FIGS. 4B and 4D, the update reply 410r is not provided in the update object ID, though the creation reply 400r is provided in the update object ID. Accordingly, no update object ID is entered to the content ID table 20a of the client terminal 10a. Although the details are left for later description, the reason for not including the update object ID is that, in the present embodiment, it is possible to read the latest contents using either update unique ID or object ID; and, thus, if a unique ID is known in advance, it is possible to acquire its corresponding object ID by transmitting an oID acquisition command to the second disk management means 110. However, it goes without saying that the update reply 410r may be surely provided with the update object ID.

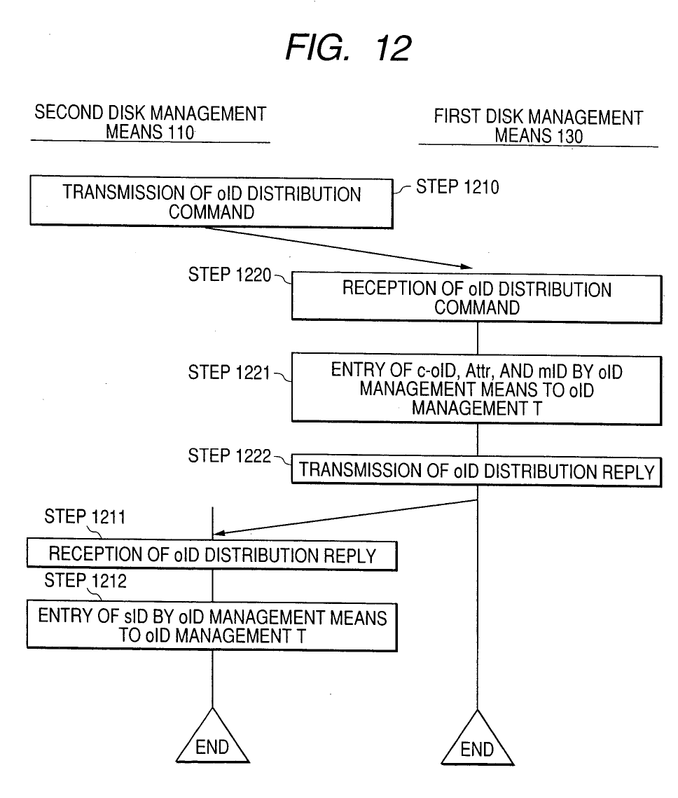

Referring to the flowchart of FIG. 12, the oID distribution process of step 616 in FIG. 6, and that of step 717 in FIG. 7 will be described next.

As already described above, after the contents are written in the disk drive 102, the oID management means 112 of the second disk management means 110 creates and sends an oID distribution command 450 of FIG. 5E for notifying the first disk management means 130 of the object ID attached to the content (S1210). The oID distribution command 450 includes the sequence ID 451, the command ID 452, the object ID 453, a c-object ID 454, the attribute 455, and the second management node ID 456 for identifying the second disk management means 110 from which the command comes. When the oID management means 132 of the first disk management means 130 receives the oID distribution command (S1220), c-oID, Attr, and mID found in the command are entered into the object management table 135 (S1221). c-oID is not yet generated when the newly-created content is written into the disk drive 102 by the second disk management means 110, and thus the oID distribution command includes no such c-oID yet. After such entry, the oID management means 132 forwards an oID distribution reply to the second disk management means 110 (S1222). When the oID management means 112 of the second disk management means 110 receives this reply (S1211), the first management node ID is entered to the oID management table 125 for identifying the first disk management means 130 that has been recognized when the oID distribution command is transmitted (S1212).

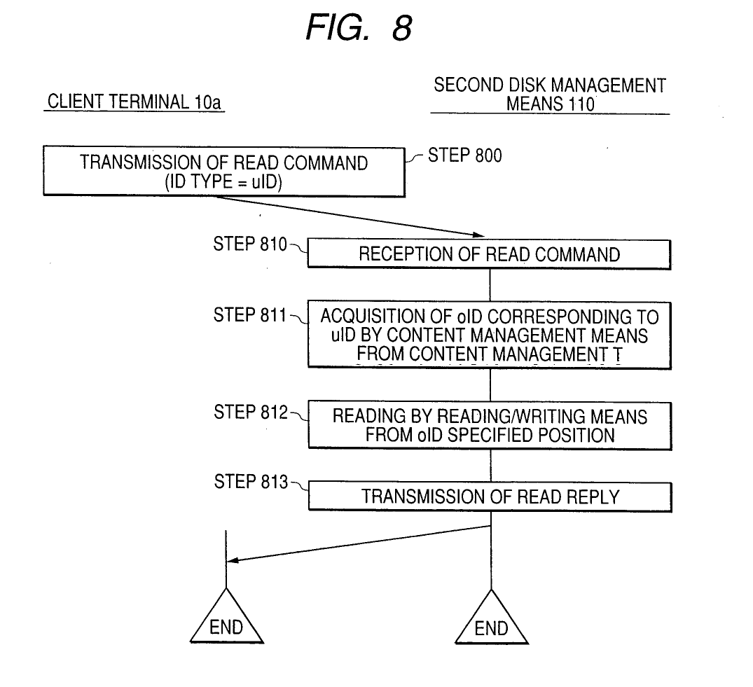

Referring to the flowchart of FIG. 8, the operation of the storage control device 101 will be described next, assuming a case where a read command is forwarded from the client terminal 10a using the application program 11a, presuming usage of unique IDs.

For reading of the content stored in the storage device 100, the client terminal 10a creates the read command 420 of FIG. 4E for transmission to the storage device 100 (S800). The read command 420 includes the sequence ID 421, the command ID 422, the ID type 423, the ID 424 of the type designated by the ID type, and the A/M flag 426. Here, the client terminal 10a selects the unique ID type as the ID type. The A/M flag 426 has no influence over the operation of the storage control device 101, no matter what setting is given to the A/M flag 426. This is because, when object ID type is selected as the ID type, the A/M flag 426 is used to identify the operation of the storage control device 101.

When the communications control means 114 of the second disk management means 110 receives such a read command (S810), the content management means 111 searches the content management table 120 for the object ID corresponding to the unique ID in the read command (S811). The thus found object ID is forwarded to the read/write means 113. In response thereto, the read/write means 113 performs content reading from the region in the disk drive 102 indicated by the object ID, and the thus read content 425 is forwarded to the communications control means 114 (S812). Upon reception of the content, the communications control means 114 creates the read reply 420r of FIG. 4F for transmission to the client terminal 10a (S813). The read reply 420r includes the contents 425 attached with the sequence ID 421 found in the read command.

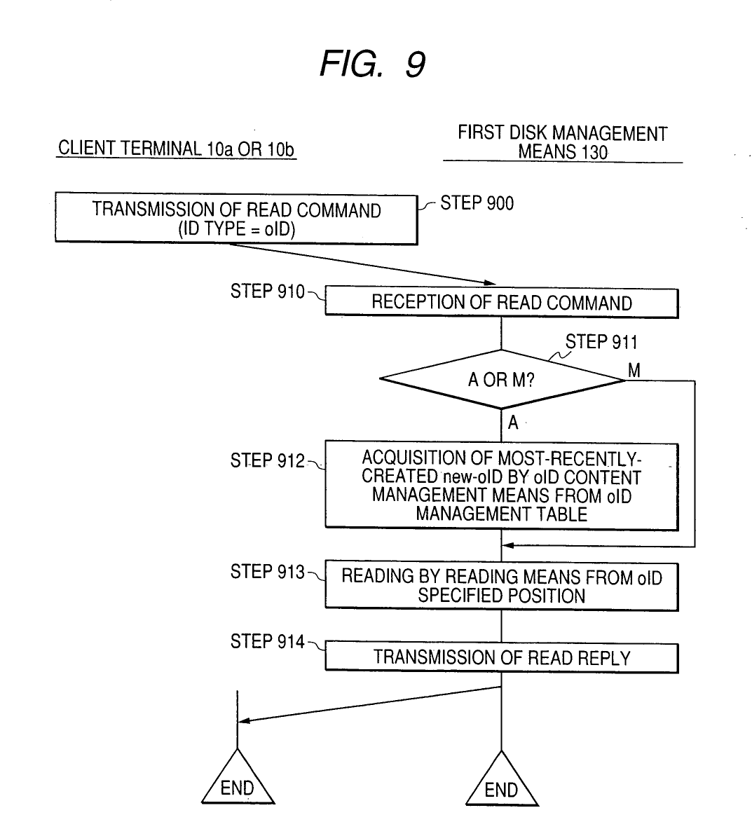

Referring to the flowchart of FIG. 9, the operation of the storage control device 101 will be described next, assuming a case where the client terminal 10a or 10b transmits the read command designated by the object ID type.

It is assumed here that the client terminal 10a or 10b designates the object ID as the ID type in the read command 420 of FIG. 4E and uses the A/M flag 426 to designate either A (Auto) or M (Manual). Here, A (Auto) means to automatically read the latest content and M (Manual) means to read the content identified by the object ID. The initial setting of the A/M flag 426 is A. After the client terminal 10a or 10b forwards such a read command to the storage device 100 (S900), the communications control means 134 of the first disk management means 130 receives the read command (S910). The oID management means 132 first analyzes the read command to see what its A/M flag is indicating (S911). When the A/M flag is indicating A, asking for automatic reading of the latest content, the oID management means 132 refers to the oID management table 135 of FIG. 4C to search the series of object IDs relating to those in the read command for the latest object ID. The thus found object ID is passed to the read means 133 (S912). When the A/M flag in the read command is indicating M, asking for reading of a content item indicated by the object ID, on the other hand, the object ID in the read command is passed to the read means 133 as it is.

Upon reception of the object ID from the oID management means 132, the read means 133 performs content reading from the region indicated by the object ID in the disk drive 102, and the thus read content is passed to the communications control means 134 (S913). That is, the object ID provided by the oID management means 132 serves as a determination factor in which to read, the latest content item or contents which are not the latest. After receiving the read content, the communications control means 134 creates the read reply 420r of FIG. 4F for transmission to the client terminal 10a or 10b (S914). Here, the read reply 420r includes the read-out content 425 attached with the sequence ID 421 found in the read command.

As such, in the present embodiment, through designation of the object ID, the client terminals 10a and 10b both can read the content stored in the region indicated by the object ID. Here, the client terminal 10a stores unique IDs, as described above and shown in FIG. 8, so that content reading is performed based on the unique IDs. Thus, for content reading based on unique IDs, the unique IDs need to be converted to object IDs. For content reading based on object IDs, on the other hand, no such ID conversion is required, thereby reducing the load of the storage control device 101, compared with content reading based on the unique IDs. Such load reduction at the time of a read request is considered immensely important because the storage device receives a read request much more frequently than it receives write requests. In consideration of such facts, the present embodiment enables content reading using object IDs while ensuring WORM with content update based on unique IDs. With such a structure, conventional application programs presuming usage of object IDs can be continuously used, and the load of the storage control device 101 can be reduced at the time of read requests.

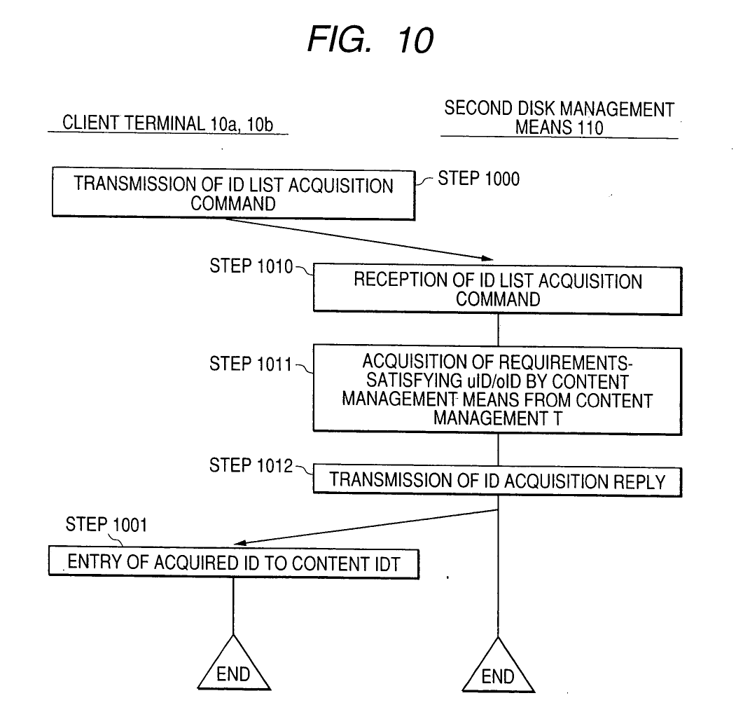

Referring to the flowchart of FIG. 10, the operation of the storage control device 101 will be described next for a case where the client terminal 10a or 10b forwards an ID list acquisition command.

The client terminal 10a or 10b creates the ID acquisition command 430 of FIG. 5A for transmission to the second disk management means 110 (S1000). The ID list acquisition command 430 includes the sequence ID 431, the command ID 432, the ID type 433, and the attribute requirement 434. The ID list acquisition command 430 is first received by the communications control means 114 of the second disk management means 110 (S010), and then it is forwarded to the content management means 111. In response thereto, the content management means 111 searches the content management table 120 for any ID corresponding to the ID type and satisfying the attribute requirement in the ID list acquisition command (S1011). The thus found IDs are passed to the communications control means 114 as the ID list. The communications control means 114 then creates the ID list acquisition reply 420r of FIG. 5B for transmission to the client terminal 10a or 10b (S1012). The ID list acquisition reply 430r includes the ID list received from the content management means 111 attached with the sequence ID.

After receiving the ID list acquisition reply, the client terminal 10a or 10b enters, to the content ID management tables 20a and 20b, the IDs found in the ID list included in the reply (S1001).

The client terminal 10b using the application program 11b, presuming usage of object IDs, and thus is not capable of content creation or update. As a result, the client terminal 10b cannot receive unique IDs and object IDs coming from the second disk management means 110 at the time of content creation and update. Here, asking for the ID list allows acquisition of IDs of content items, which in turn makes it possible for contents to be read from the client terminal 10b.

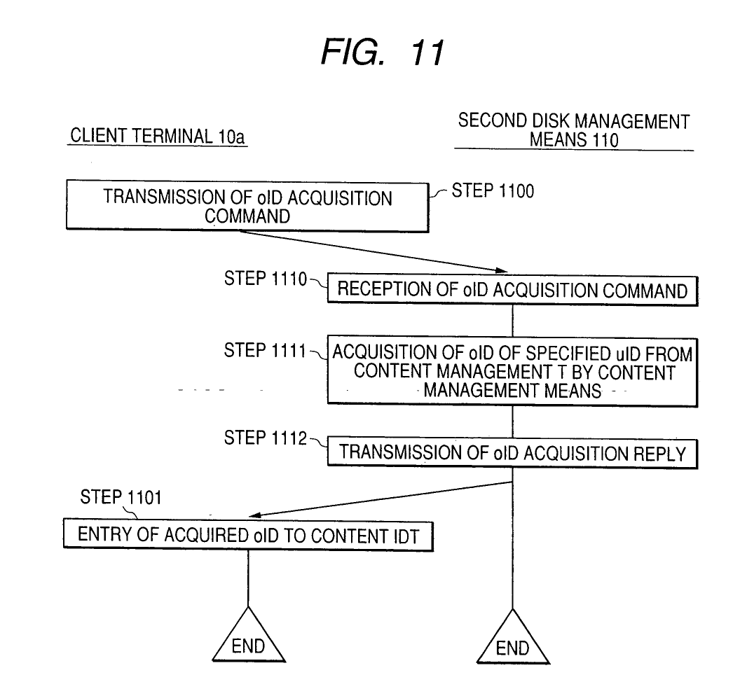

Referring to the flowchart of FIG. 11, the operation of the storage control device 101 will be described next for a case where the client terminal 10b transmits an ID acquisition command. As mentioned above, the client terminal 10a can acquire the unique ID of an updated content, but not the object ID thereof, at the time of content update. Thus, transmitting an ID acquisition command is used to allow the client terminal 10a to perform content reading using object IDs. In the present embodiment, the ID acquisition command is used to designate the unique ID so that the object ID corresponding thereto can be acquired, in turn allowing read out of one item from a series of content items using the object ID.

The client terminal 10a creates the ID acquisition command 440 of FIG. 5C and transmits it to the second disk management means 110 (S1100). The ID acquisition command 440 includes the sequence ID 441, the command ID 442, and the unique ID 443 corresponding to the object ID that is desired. The ID acquisition command is first received by the communications control means 114 of the second disk management means 110 (S1110), and then it is forwarded to the content management means 111. The content management means 111 then searches the content management table 120 for the object ID corresponding to the unique ID in the ID acquisition command (S1111), and the thus found object ID is passed to the communications control means 114. The communications control means 114 creates the ID acquisition reply 440r of FIG. 5D and sends it to the client terminal 10a (S1112). The ID acquisition reply 440r includes the object ID list received from the content management means 111, and it is attached with the sequence ID.

In response to the ID acquisition reply, the client terminal 10a enters, to the content ID management table 20a, the object ID found in the reply (S1101).

As such, in the present embodiment, the advantage of content WORM is favorably ensured thanks to the second disk management means 110, which makes access to the disk drive 102 based on a unique ID that is unique to any specific object. Also provided herein is the first disk management means 130 that performs content reading based on an object ID that is unique to the region in the disk drive 102. With such a structure, content reading does not require management of unique IDs which show some change responding to any content change, thereby favorably reducing the clients' load. What is more, conventional application programs with a prerequisite for usage of object IDs can be used. Further, in the present embodiment, object reading using object IDs can reduce the load for converting unique IDs to object IDs at the time of object reading using unique IDs.

Still further, in the present embodiment, the first disk management means 130 includes its own communications port 139, and the second disk management means 110 also includes its own communications port 119. However, the present invention is not restrictive thereto. In an alternate structure, the first and second management means 130 and 110 may share a communications port, which takes charge of allocation between these two management means 110 and 130 depending on the header addresses or requests in the commands coming from the client terminals 10a and 10b.

Still further, in the above-described embodiment, the storage device 100, including a plurality of disk drives 102, is provided with the storage control device 101. Alternatively, the storage control device may be provided separately from the disk drives.

Still further, the structure in the above-described embodiment includes, separately, the first disk management means 130 executing a read process and others with respect to the disk drives 102 based on object IDs, and the second disk management means 110 executing a read/write process and others with respect to the disk drives 102 based on the unique IDs. In an alternate structure, one management means may take charge of operations of the above-described two management means. If this is the case, the management means may determine which operation is to take charge based on IDs and others found in each received command.

Still further, the client terminal that has performed data reading based on object IDs takes charge of the reading of an object ID list directly from the storage control device 101. Alternatively, a specific computer may read a list relating to object IDs and others collectively from the storage control device 101 for distribution to client terminals. Such a structure can reduce the load relating to the storage control device 101 from list managers.

According to the present invention, object WORM is successfully ensured thanks to the second storage management means, which is provided for making access to storage devices based on unique IDs that are unique to object IDs. Further, in accordance with the present invention, the first storage management means is provided for object reading based on object IDs that are unique to a region in the storage devices. Thanks to this, object reading does not require management of unique IDs showing some change responding to any content change, thereby favorably reducing the clients' load. What is more, conventional application programs with a prerequisite for usage of object IDs can be used. Further, in accordance with the present invention, object reading using object IDs can reduce the load for converting unique IDs to object IDs at the time of object reading using unique IDs.

Focusing on such problems of the conventional technology, the present invention can successfully ensure WORM by using unique IDs, favorably reduce clients' load, and be compatible to any existing application programs through provision of a storage control device, an operation program therefor, and an access control method.

1. A storage system, comprising:
one or more of a storage device storing an object containing a collection of data; and
a storage control device for controlling access to the object stored in the storage device, wherein
the storage control device further comprises:
first storage management means for, when a read request coming from an external device includes an object ID unique to a region in the storage device, reading an object from the region indicated by the object ID in the storage device for passing the object to the external device; and
second storage management means for, when an access request coming from the external device includes a unique ID that is unique to the object and changes every time the object is updated, accessing the storage device based on the unique ID to execute the access request.

2. A storage system according to claim 1, wherein
the first and second storage management means have each different communications port for communications with the external device.

3. A storage system according to claim 2, further comprising
communications control means for passing a request coming from the external device to the first storage management means when the request includes an object ID and to the second storage management means when the request includes a unique ID.

4. A storage system according to claim 3, wherein
the second storage management means further comprises a content management table storing an interrelation between the unique ID and the object ID, wherein
when the read request coming from the external request includes the unique ID, the second storage management means refers to the content management table to find an object ID corresponding to the unique ID, and reads the object stored in the region indicated by the object ID in the storage device for passing the object to the external device.

5. A storage system according to claim 4, wherein
the first storage management means further comprises an object ID management table storing, in an interrelated manner, a pre-update object ID of a new object and a post-update object ID of an update object corresponding to the new object, wherein
when the read request coming from the external device includes the pre-update object ID, the first storage management means refers to the object ID management table to find the latest post-update object ID interrelated to the pre-update object ID, and reads an object written into a region indicated by the latest post-update object in the storage device for transmission to the external device.

6. A storage system according to claim 5, wherein
when the read request coming from the external device includes either the pre-update object ID or the post-update object ID, and when information is included asking for the object in the region indicated by the pre-update object or the post-update object, the first storage management means selects the pre-update or post-update object ID, and selects from the object ID management table the latest post-update object ID interrelated to the pre-update or post-update object ID when included is information asking for the object in the region indicated by the latest post-update object ID.

7. A storage system according to claim 1, wherein
the second storage management means further comprises a content management table storing an interrelation between the unique ID and the object ID, wherein
when a new object comes from the external device responding to a creation request, the second storage management means generates a pre-update unique ID for the new object for storage into the content management table, generates a pre-update object ID for the pre-update unique ID for storage into the content management table, stores the new object to a position indicated by the pre-update object ID in the storage device, and transmits the pre-update unique ID and the pre-update object ID to the external device.

8. A storage system according to claim 7, wherein
after receiving an object update request including the update object and the pre-update unique ID from the external device, the second storage management means generates a post-update unique ID for the update object for storage into the content management table, generates a post-update object ID for the post-update unique ID for storage into the content management table, and stores the update object to a position indicated by the post-update object ID in the storage device for transmission to the external device.

9. A storage system according to claim 8, wherein
the second storage management means transmits the pre-update object ID to the first storage management means when the pre-update object ID is generated, and the post-update object ID to the second storage management means when the post-update object ID is generated, wherein
the first storage management means further comprises an object ID management table storing a pre-update object ID for a new object, and a post-update object ID for an update object corresponding to the new object in an interrelated manner, wherein
the first storage management means stores the pre-update object ID and the post-update object ID coming from the second storage management means to the object ID management table in an interrelated manner, and when the read request coming from the external device includes the pre-update object ID, refers to the object ID management table to find the latest post-update object interrelated to the pre-update object ID, and in the storage device, reads an object written into a region indicated by the found latest post-update object ID for transmission to the external device.

10. A storage system, comprising:
one or more of a storage device storing an object containing a collection of data; and
a storage control device for controlling access to the object stored in the storage device, wherein
the storage control device further comprises:
a processor;
memory; and
a plurality of ports for connection with another device over a network, wherein
when a read request coming from the another device through the port includes an object ID unique to a region in the storage device, the processor reads an object from the region in the storage device indicated by the object ID for transmission to the another device over the network, and
when the read request includes a unique ID being unique to the object and showing a change when the object is updated, the processor makes access to the storage device based on the unique ID to read the object corresponding to the unique ID for transmission to the another device, wherein
the memory stores information indicating an interrelation between the unique ID and the object ID, wherein
when the read request coming from the another device includes the unique ID, the processor refers to the information to find the object ID corresponding to the unique ID, and reads the object written into the region in the storage region indicated by the found object ID for transmission to the another device.

11. A data access method in a storage system including one or more of a storage device storing an object containing a collection of data, the method comprising:
a first step of, when a read request coming from an external device includes an object ID unique to a region in the storage device, reading an object from the region indicated by the object ID in the storage region for transmission to the external device; and
a second step of, when an access request coming from the external device includes a unique ID being unique to the object and showing a change when the object is updated, making access to the storage device based on the unique ID to execute the access request.

12. A data access method according to claim 11, wherein
the second step further comprises the steps of:
referring to, when the read request from the external device includes the unique ID, a content management table storing an interrelation between the unique ID and the object ID to acquire an object ID corresponding to the unique ID; and
reading the object written into the region in the storage region indicated by the object ID for transmission to the external device.

13. A data access method according to claim 12, wherein
the first step further comprises the steps of:
referring to, when the read request coming from the external device includes an object ID, an object ID management table storing information interrelating an object ID of an arbitrary object to another object ID to be created when the arbitrary object is updated (in the below, “post-update object ID”) to extract the latest post-update object ID interrelated to the object ID; and
reading the object written into the region in the storage device indicated by the latest update object ID for transmission to the external device.

14. A data access method according to claim 13, wherein
the first step further comprises the steps of:
when the read request coming from the external device includes the object ID, and when information is included asking for an object of a region indicated by the object ID, selecting the object ID; and
when information included is asking for the object in the region indicated by the latest post-update object ID, extracting from the object ID management table the latest post-update object ID interrelated to the object ID.

15. A data access method according to claim 11, wherein
the second step further comprises the steps of:
generating, when receiving a new object from the external device responding to a write request, a unique ID for the new object for storage into the content management table;
generating an object ID corresponding to the unique ID for storage into the content management table; and
storing the new object to a position indicated by the object ID in the storage device, and transmitting the unique ID and the object ID to the external device.

16. A data access method according to claim 15, wherein
the second step further comprises the steps of:
generating, when an update object is received together with the unique ID from the external device responding to an object update request, a unique ID for the update object (hereinafter, “post-update unique ID”) for storage into the content management table;
generating an object ID for the post-update unique ID (hereinafter, “post-update object ID”) for storage into the content management table; and
storing the update object to a position indicated by the post-update object ID in the storage device for transmission to the external device.

17. A data access method according to claim 16, wherein
the first step further comprises the steps of:
storing, to the object ID management table, the object ID and the post-update object ID generated in the second step in an interrelated manner;
referring to, when the read request coming from the external device includes the object ID, the object ID management table to find the latest post-update object ID interrelated to the object ID; and
reading the object written into the region indicated by the latest post-update object ID in the storage device for transmission to the external device.

18. A data access method according to claim 17, wherein
the second step further comprises the steps of:
storing, to the content management table, the unique ID of the new object and the post-update unique ID of the update object corresponding to the new object in an interrelated manner;
storing the object ID in the content management table in an interrelated manner to the unique ID, and storing the post-update object ID to the content management table in an interrelated manner to the post-update unique ID; and
when an ID list request comes from the external device for the unique ID or the object ID, extracting based on the ID list request, from the content management table one or more of a unique ID interrelated to each other, or one or more of an object ID interrelated to each other, and transmitting the unique ID or the object ID to the external device.

19. A data access method according to claim 18, wherein
the second step stores to the content management table both attribute information of the new object interrelated to the unique ID of the new object, and attribute information of the update object interrelated to the post-update unique ID of the update object, and when the ID list request coming from the external device for the unique ID or the object ID is asking for a specific attribute, based on the ID list request, extracts from the content management table one or more of an interrelating unique ID satisfying the attribute asked in the ID list request, or one of more of an interrelating object ID satisfying the attribute asked in the ID list request, and transmits the unique ID or the object ID to the external device.

20. A data access method according to claim 19, wherein
in the second step, when an object ID request comes from the external device asking for the object ID corresponding to the unique ID, the object ID corresponding to the unique ID is extracted from the content management table for transmission to the external device.
